(19) United States
(12) Patent Application Publication
(10) Pub. No.: US 2012/0152390 A1
(43) Pub. Date: Jun. 21, 2012

(54) Mixed Water Control Valve Having A Water Pressure Balance Function to Stabilize Water Temperature

(76) Inventor: Chia-Po Chang, Ho-Mei Town (TW)

(21) Appl. No.: 12/972,601

(22) Filed: Dec. 20, 2010

(51) Int. Cl. F16K 15/14

(52) U.S. Cl. 137/843

(57) ABSTRACT

A mixed water control valve for a faucet includes a control unit and a balance unit mounted in the control unit. The control unit includes a valve housing. The balance unit includes two mounting seats each mounted in the valve housing, a hollow fixed sleeve secured in the mounting seats, a pressure regulating sleeve movably mounted in the fixed sleeve, a balance baffle mounted in the pressure regulating sleeve, and two elastic members each mounted in the pressure regulating sleeve and each biased between the balance baffle and a respective one of the mounting seats. Thus, the balance baffle is compressed between the elastic members which provide a buffering force to counteract a larger pressure applied on the balance baffle, so that the pressure regulating sleeve is moved smoothly and stably without producing resonant noise in the faucet.

### BACKGROUND OF THE INVENTION

1. Field of the Invention

The present invention relates to a control valve and, more particularly, to a mixed water control valve for a faucet to control the temperature of a mixture of cold and hot water of the faucet.

2. Description of the Related Art

A conventional faucet comprises a control valve to mix the cold water from a cold water source and the hot water from a hot water source and to inject the mixed water outwardly for use with a user. Thus, the mixed water has a proper temperature so that the user can use the water comfortably. However, when the water flow from the cold water source or the hot water source is reduced or stops accidentally due to an irregular condition, the water pressure of the cold and hot water is not balanced, so that the water temperature is increased or decreasing to an excessive extent instantaneously to make the water too hot or too cold, thereby easily causing an uncomfortable sensation to the user due to the too cold water or evenly causing danger to the user due to the too hot water (the user is easily scalded by the too hot water).

A conventional control valve for a faucet comprises a valve housing, and a balance unit mounted in the valve housing. The balance unit includes two juxtaposed mounting seats each mounted in the valve housing, a hollow fixed sleeve secured in the two mounting seats, and a pressure regulating sleeve movably mounted in the fixed sleeve. Each of the two mounting seats of the balance unit has an inner portion provided with a water inlet hole. The water inlet hole of one of the two mounting seats is connected to a cold water source, and the water inlet hole of the other one of the two mounting seats is connected to a hot water source. In operation, the cold water from the cold water source and the hot water from the hot water source in turn flow through the water inlet holes of the mounting seats and the fixed sleeve into the pressure regulating sleeve respectively. In such a manner, when the water flow of a first one (for example, the cold water terminal) of the mounting seats is reduced accidentally or stopped abnormally due to an irregular condition, the water pressure of the first one (the cold water terminal) of the mounting seats is reduced or disappears. Thus, the greater water pressure of a second one (for example, the hot water terminal) of the mounting seats will push the pressure regulating sleeve so that the pressure regulating sleeve is moved in the fixed sleeve so as to reduce or stop the water flow of the second one (the hot water terminal) of the mounting seats. Thus, the pressure regulating sleeve is moved by a pressure differential between the water inlet holes of the mounting seats so that the water flow of the water inlet holes of the mounting seats can be regulated by movement of the pressure regulating sleeve so as to achieve a water pressure balance and to stabilize the temperature of the mixed water in the valve housing. However, when the (cold or hot) water only flows through one of the mounting seats, while other water equipment is also opened simultaneously, a larger pressure is applied on the pressure regulating sleeve to push and move the pressure regulating sleeve violently, thereby easily producing a resonant noise in the faucet. In addition, the pressure regulating sleeve is moved quickly in the fixed sleeve due to the larger pressure so that the pressure regulating sleeve will hit or wear the fixed sleeve, thereby decreasing the lifetime of the balance unit.

### BRIEF SUMMARY OF THE INVENTION

In accordance with the present invention, there is provided a mixed water control valve, comprising a control unit and a balance unit mounted in the control unit. The control unit includes a valve housing. The valve housing of the control unit has an inner portion provided with a receiving chamber to receive the balance unit. The balance unit includes two mounting seats each mounted in the receiving chamber of the valve housing, a hollow fixed sleeve secured in the two mounting seats, a pressure regulating sleeve movably mounted in the fixed sleeve, a balance baffle mounted in the pressure regulating sleeve, and two elastic members each mounted in the pressure regulating sleeve and each biased between the balance baffle and a respective one of the two mounting seats.

According to the primary advantage of the present invention, the balance baffle is compressed between the two elastic members which provide a buffering force to counteract the larger pressure applied on the balance baffle when the water only flows through the water inlet hole of one of the two mounting seats, so that the pressure regulating sleeve is moved smoothly and stably without producing resonant noise in the faucet.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a mixed water control valve for a faucet in accordance with the preferred embodiment of the present invention.

FIG. 2 is an exploded perspective view of the mixed water control valve for a faucet as shown in FIG. 1.

FIG. 3 is another exploded perspective view of the mixed water control valve for a faucet as shown in FIG. 1.

FIG. 4 is a front cross-sectional view of the mixed water control valve for a faucet as shown in FIG. 1.

FIG. 5 is a schematic operational view of the mixed water control valve for a faucet as shown in FIG. 4.

FIG. 6 is a schematic operational view of the mixed water control valve for a faucet as shown in FIG. 4.

### DETAILED DESCRIPTION OF THE INVENTION

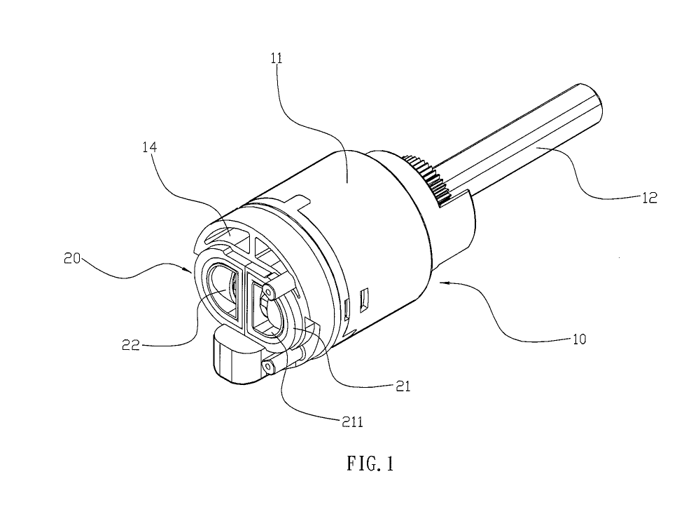

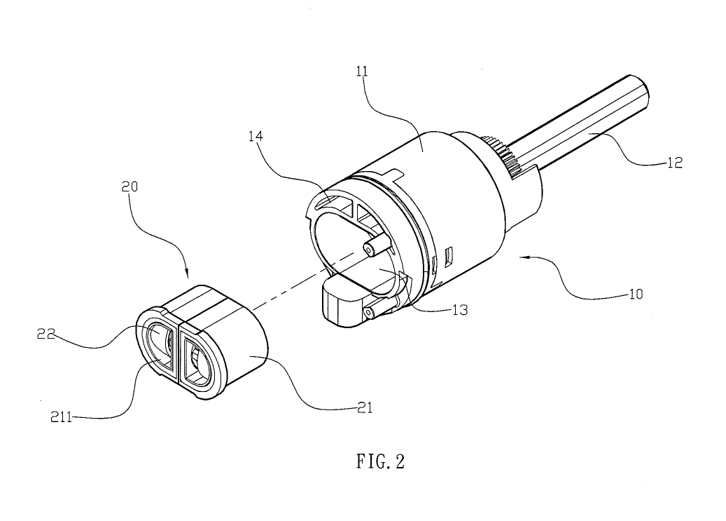

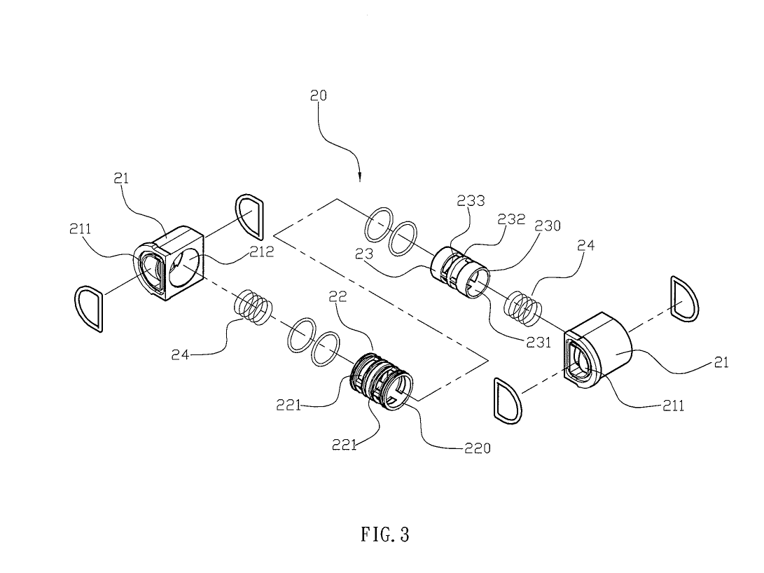

Referring to the drawings and initially to FIGS. 1-4, a control valve for a faucet in accordance with the preferred embodiment of the present invention comprises a control unit 10 and a balance unit 20 mounted in the control unit 10.

The control unit 10 includes a valve housing 11, a switching module adjustably mounted in the valve housing 11 to regulate the water flow in the valve housing 11, and a protruding control handle 12 rotatably mounted on the valve housing 11 and connected with the switching module to operate the switching module so as to open/close the water flow in the valve housing 11 or to change the mixed proportion of the hot and cold water in the valve housing 11.

The valve housing 11 of the control unit 10 has an inner portion provided with a receiving chamber 13 to receive the balance unit 20 and has a side provided with a water outlet hole 14.

The balance unit 20 includes two juxtaposed mounting seats 21 each mounted in the receiving chamber 13 of the valve housing 11, a hollow fixed sleeve 22 secured in the two mounting seats 21, a pressure regulating sleeve 23 movably mounted in the fixed sleeve 22, a balance baffle 232 mounted in the pressure regulating sleeve 23, and two elastic members 24 each mounted in the pressure regulating sleeve 23 and each biased between the balance baffle 232 and a respective one of the two mounting seats 21.

Each of the two mounting seats 21 of the balance unit 20 has an inner portion provided with a water inlet hole 211 and has a side provided with a receiving hole 212 to receive the fixed sleeve 22. The receiving hole 212 of each of the two mounting seats 21 is connected to the water inlet hole 211. The water inlet hole 211 of one of the two mounting seats 21 is connected to a cold water source (not shown), and the water inlet hole 211 of the other one of the two mounting seats 21 is connected to a hot water source (not shown).

The fixed sleeve 22 of the balance unit 20 has two open ends 220 each connected to the receiving hole 212 of a respective one of the two mounting seats 21. The fixed sleeve 22 of the balance unit 20 has a periphery provided with two connecting grooves 221 each connected to the water inlet hole 211 of a respective one of the two mounting seats 21.

The pressure regulating sleeve 23 of the balance unit 20 has two open ends 230 each connected to the receiving hole 212 of a respective one of the two mounting seats 21. The pressure regulating sleeve 23 of the balance unit 20 has a periphery provided with two connecting slots 233 each movable to align or partially align with a respective one of the two connecting grooves 221 of the fixed sleeve 22. The pressure regulating sleeve 23 of the balance unit 20 has an inner portion provided with two receiving spaces 231 to receive the two elastic members 24. Each of the two receiving spaces 231 of the pressure regulating sleeve 23 is connected to a respective one of the two connecting slots 233 and is connected to the receiving hole 212 of a respective one of the two mounting seats 21.

The balance baffle 232 of the balance unit 20 is located at a middle position of the pressure regulating sleeve 23 and is located between the two receiving spaces 231. The balance baffle 232 of the balance unit 20 is also located between the two connecting slots 233. The balance baffle 232 of the balance unit 20 is compressed between the two elastic members 24 so that the pressure regulating sleeve 23 of the balance unit 20 is kept at a middle position of the fixed sleeve 22 by the two elastic members 24.

Each of the two elastic members 24 of the balance unit 20 is received in a respective one of the two receiving spaces 231 of the pressure regulating sleeve 23. Each of the two elastic members 24 of the balance unit 20 is a compression spring and has a first end pressing the balance baffle 232 and a second end pressing an inner peripheral wall of a respective one of the two mounting seats 21.

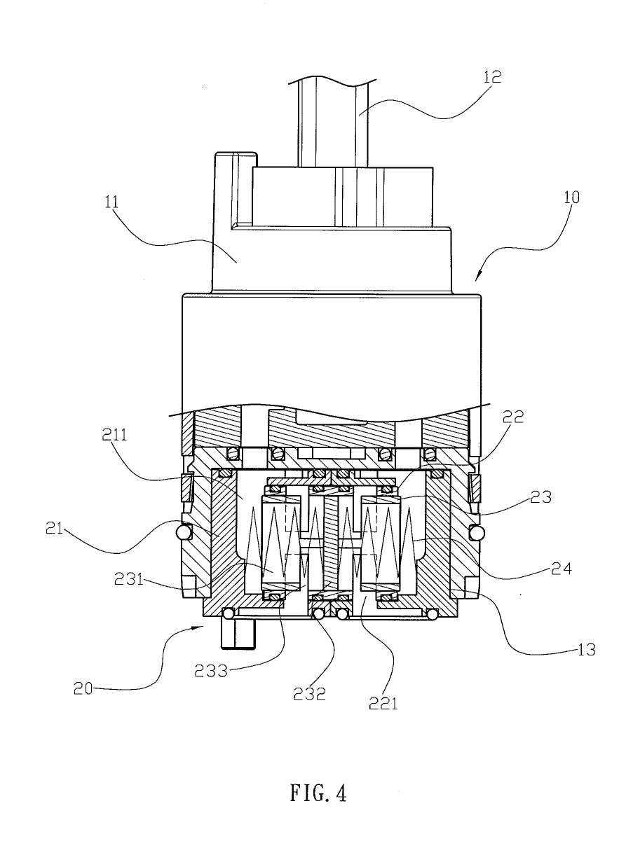

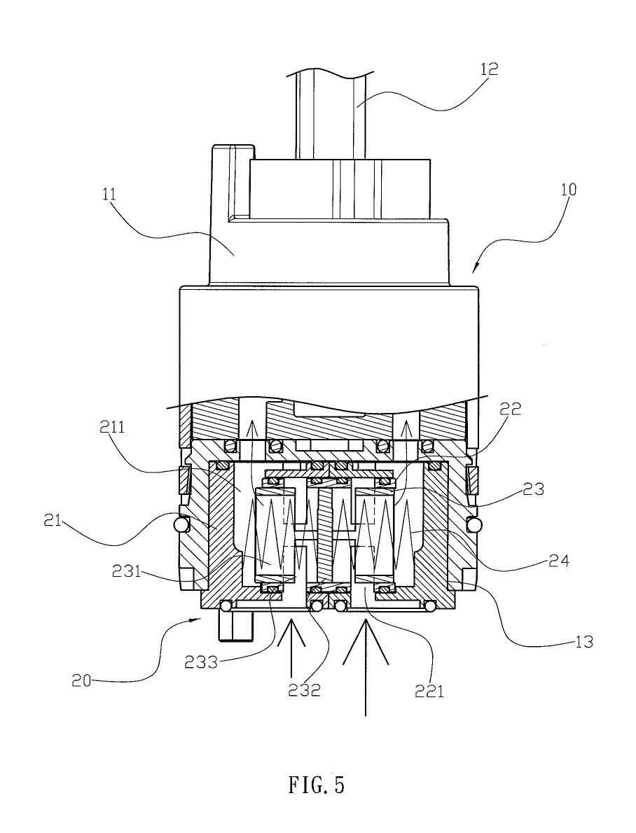

In operation, referring to FIGS. 4 and 5 with reference to FIGS. 1-3, the cold water from the cold water source and the hot water from the hot water source in turn flow through the water inlet hole 211 of each of the two mounting seats 21, the two connecting grooves 221 of the fixed sleeve 22 and the two connecting slots 233 of the pressure regulating sleeve 23 into the two receiving spaces 231 of the pressure regulating sleeve 23 respectively. In such a manner, when the water flow of the water inlet hole 211 of a first one (for example, the cold water terminal) of the two mounting seats 21 is reduced accidentally or stopped abnormally due to an irregular condition, the water pressure of the first one (the cold water terminal) of the two mounting seats 21 is reduced or disappears. Thus, the greater water pressure of a second one (for example, the cold water terminal) of the two mounting seats 21 will push the balance baffle 232 of the balance unit 20 toward the first one (the cold water terminal) of the two mounting seats 21, so that the pressure regulating sleeve 23 is moved in the fixed sleeve 22 to reduce or block the overlapping area of the respective connecting groove 221 of the fixed sleeve 22 and the respective connecting slot 233 of the pressure regulating sleeve 23 at the second one of the two mounting seats 21 so as to reduce or stop the water flow of the second one of the two mounting seats 21. Thus, the pressure regulating sleeve 23 is moved by a pressure differential between the water inlet holes 211 of the two mounting seats 21 so that the water flow of the water inlet holes 211 of the two mounting seats 21 can be regulated by movement of the pressure regulating sleeve 23 so as to achieve a water pressure balance and to stabilize the temperature of the mixed water in the valve housing 11.

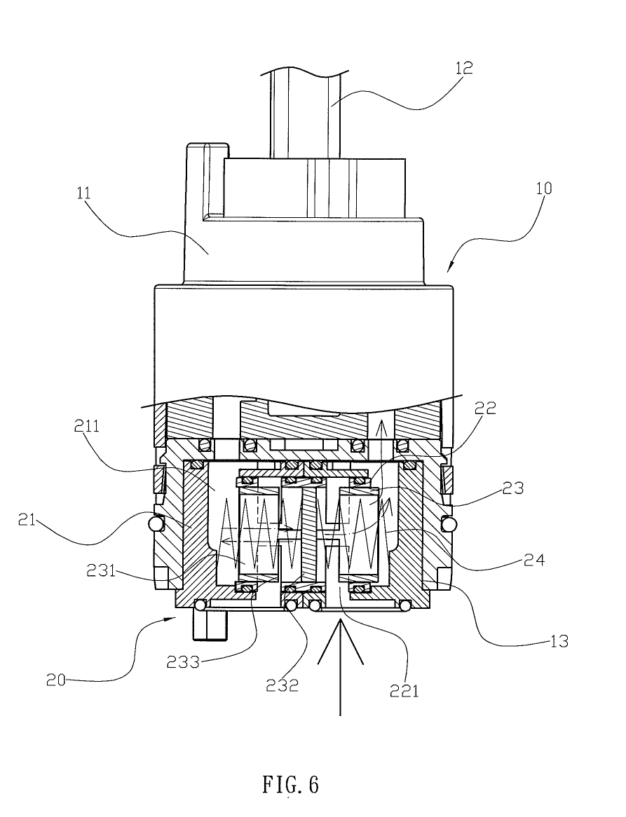

As shown in FIG. 6, the (cold or hot) water only flows through the water inlet hole 211 of one of the two mounting seats 21, while other water equipment is also opened simultaneously so that a larger pressure is applied on the balance baffle 232 to push and move the pressure regulating sleeve 23 violently. At this time, the two elastic members 24 press the balance baffle 232 to provide a buffering force to counteract the larger pressure applied on the balance baffle 232 so that the pressure regulating sleeve 23 is moved smoothly and stably without producing resonant noise in the faucet. In addition, the pressure regulating sleeve 23 is moved slowly in the fixed sleeve 22 so that the pressure regulating sleeve 23 will not hit or wear the fixed sleeve 22 so as to enhance the lifetime of the balance unit 20.

Accordingly, the balance baffle 232 is compressed between the two elastic members 24 which provide a buffering force to counteract the larger pressure applied on the balance baffle 232 when the water only flows through the water inlet hole 211 of one of the two mounting seats 21, so that the pressure regulating sleeve 23 is moved smoothly and stably without producing resonant noise in the faucet. In addition, the pressure regulating sleeve 23 is moved slowly in the fixed sleeve 22 by buffering of the two elastic members 24 so that the pressure regulating sleeve 23 will not hit or wear the fixed sleeve 22 so as to enhance the lifetime of the balance unit 20.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A mixed water control valve, comprising:
a control unit; and
a balance unit mounted in the control unit;
wherein the control unit includes a valve housing;
the valve housing of the control unit has an inner portion provided with a receiving chamber to receive the balance unit;
the balance unit includes:
two mounting seats each mounted in the receiving chamber of the valve housing;
a hollow fixed sleeve secured in the two mounting seats;
a pressure regulating sleeve movably mounted in the fixed sleeve;
a balance baffle mounted in the pressure regulating sleeve; and
two elastic members each mounted in the pressure regulating sleeve and each biased between the balance baffle and a respective one of the two mounting seats.

2. The mixed water control valve of claim 1, wherein
the pressure regulating sleeve of the balance unit has an inner portion provided with two receiving spaces to receive the two elastic members;
the balance baffle of the balance unit is located at a middle position of the pressure regulating sleeve;
the balance baffle of the balance unit is located between the two receiving spaces;
the balance baffle of the balance unit is compressed between the two elastic members;
the pressure regulating sleeve of the balance unit is kept at a middle position of the fixed sleeve by the two elastic members;
each of the two elastic members of the balance unit is received in a respective one of the two receiving spaces of the pressure regulating sleeve.

3. The mixed water control valve of claim 2, wherein
the valve housing of the control unit has a side provided with a water outlet hole;
each of the two mounting seats of the balance unit has an inner portion provided with a water inlet hole and has a side provided with a receiving hole to receive the fixed sleeve;
the receiving hole of each of the two mounting seats is connected to the water inlet hole;
the fixed sleeve of the balance unit has two open ends each connected to the receiving hole of a respective one of the two mounting seats;
the fixed sleeve of the balance unit has a periphery provided with two connecting grooves each connected to the water inlet hole of a respective one of the two mounting seats;
the pressure regulating sleeve of the balance unit has two open ends each connected to the receiving hole of a respective one of the two mounting seats;
the pressure regulating sleeve of the balance unit has a periphery provided with two connecting slots each movable to align or partially align with a respective one of the two connecting grooves of the fixed sleeve;
each of the two receiving spaces of the pressure regulating sleeve is connected to a respective one of the two connecting slots and is connected to the receiving hole of a respective one of the two mounting seats;
the balance baffle of the balance unit is located between the two connecting slots;
each of the two elastic members of the balance unit is a compression spring;
each of the two elastic members of the balance unit has a first end pressing the balance baffle and a second end pressing an inner peripheral wall of a respective one of the two mounting seats.

4. The mixed water control valve of claim 1, wherein the control unit further includes:
a switching module adjustably mounted in the valve housing to regulate a water flow in the valve housing; and
a protruding control handle rotatably mounted on the valve housing and connected with the switching module to operate the switching module so as to open/close the water flow in the valve housing or to change a mixed proportion of the hot and cold water in the valve housing.
